(19) United States
(12) Patent Application Publication
(10) Pub. No.: US 2024/0383726 A1
(43) Pub. Date: Nov. 21, 2024

(54) ELEVATOR DOOR ARRANGEMENT AND METHOD

(71) Applicant: KONE Corporation, Helsinki (FI)

(72) Inventors: Eric SESTU, Helsinki (FI); Paolo CALVIO, Helsinki (FI)

(73) Assignee: KONE Corporation, Helsinki (FI)

(21) Appl. No.: 18/627,728

(22) Filed: Apr. 5, 2024

(30) Foreign Application Priority Data
May 16, 2023 (EP) 23173665.3

(51) Int. Cl. B66B 13/08; B66B 13/30

(52) U.S. Cl. CPC B66B 13/08; B66B 13/301

(57) ABSTRACT

An elevator door arrangement comprises an elevator door panel (1) and a door sill (30), the door panel (1) being movable along the door sill (30); the door panel (1) comprises at the bottom at least one panel slider bracket (10) being movable in a groove (31) of the door sill (30); and the arrangement comprises at least one panel slider (20) mountable to said at least one slider bracket (10) and slidable in the groove (31); wherein the slider bracket (10) comprises a lateral protruding lower part (11) which is configured inside the sill (30) to extend below a sill structure (32). A method for guiding an elevator door in an elevator door arrangement.

### FIELD OF THE INVENTION

The invention relates to an elevator door arrangement and a method for guiding an elevator door, in particular preventing elevator door panel derailment.

### BACKGROUND OF THE INVENTION

In connection with an elevator door, the interface between door sill and panels shall have features retaining a door panel in position should a guiding element fixed to the door panel such as a panel slider fail, as requested by EN81-20. Such devices shall prevent panel derailment from a sill groove when panels will be subject to impacts perpendicular to door opening direction.

Furthermore, in case of vandal proof doors such interface must contribute to guaranteeing proper functioning of the door even after aforementioned impacts, as requested by EN81-71.

Retaining features, commonly implemented in industry as components hooking panel to door sill still, must not prevent movements needed during installation, as engagement of panel fire labyrinths on door frame.

In prior art, EN81-20 compliant retaining features are typically integrated in slider brackets or other devices meant to be assembled on site, as finalization of door panel installation sequence, after movements to hung panel to hangers and to engage panel fire labyrinths (if present) on door frame will be performed. This can expose the design to code compliancy issues and safety risks for passengers in case fasteners securing panel-sill interface components will fail due to poor installation or human mistakes. Sensibility to human mistake is particularly true in case retaining features are integrated in slider bracket designed to be periodically disassembled and inspected during maintenance visits.

### SUMMARY OF THE INVENTION

An object of the present invention is to present an improved elevator door arrangement and a method for guiding an elevator door in an elevator door arrangement. An object of the present invention is a design where features preventing panel derailment as required by EN81-20 are part of panel slider bracket, which is irremovable and assembled during panel manufacturing. This will improve safety of the elevator door and remove risks mentioned above.

According to an embodiment the panel slider bracket is designed to trip and engage on a sill profile when doors are impacted, but still guarantees enough clearances with sill profile allowing door panel installation.

It is brought forward a new elevator door arrangement comprising an elevator door panel and a door sill, the door panel being movable along the door sill;
the door panel comprises at the bottom at least one panel slider bracket being movable in a groove of the door sill; and
the arrangement comprises at least one panel slider mountable to said at least one slider bracket and slidable in the groove; wherein
the slider bracket comprises a lateral protruding lower part which is configured inside the sill to extend below a sill structure.

According to an embodiment, the slider bracket is assembled to the door panel during panel manufacturing.

According to an embodiment, the slider bracket is irremovable in the assembled state of the elevator door arrangement.

According to an embodiment, the panel slider bracket is riveted with rivets to the door panel.

According to an embodiment, the slider bracket, when installed in the groove of the sill, is configured to generate a panel-sill hook.

According to an embodiment, the slider bracket comprises a hook formed lower part.

According to an embodiment, the slider bracket is made of metal sheet.

According to an embodiment, the slider bracket has a lower part, which is configured in such a way that when it is installed inside the sill though the groove, the lower part is positioned below the sill structure, thus forming a vertical gap between the lower part and the sill structure.

According to an embodiment, the slider bracket has a lower part comprising a lateral protruding extension to be assembled below a sill structure inside the sill.

According to an embodiment, the lower part of the slider bracket comprises a horizontal bend for retaining the door panel against upward movement.

According to an embodiment, the lateral protruding lower part such as the retaining bend is configured to catch on a sill profile edge and hook the door when the door panel lifts as effect of pendulum impacts.

According to an embodiment, the panel slider is configured to limit the vertical clearance between the lower part and the sill.

According to an embodiment, the panel slider comprises an articulated appendix configured to limit the vertical clearance between the lower part and the sill.

According to an embodiment, the articulated appendix is configured to bend following the shape of the slider bracket lower end during installation.

According to an embodiment, the articulated appendix is pivotable according to the shape of the lower part of the slider bracket.

According to an embodiment, the articulated appendix is provided at a lower end of the sliding part.

According to an embodiment the articulated appendix is pivoted at an area or point below the sliding part. According to an embodiment said area or point comprises a joint or pivot. According to an embodiment said area or point comprises material with reduced material thickness and/or flexible material.

According to an embodiment the articulated appendix is pivotable to a position perpendicular to a vertical assembly and disassembly movement direction of the slider.

According to an embodiment the slider comprises an articulated appendix acting as an integrated deformable shim. According to an embodiment the articulated appendix will act as a shim while being positioned in the vertical gap between the lower part of the bracket and the sill.

According to an embodiment the articulated appendix comprises a nose part configured to follow the shape of the lower part. According to an embodiment the nose part comprises a rounded or chamfered shape to facilitate following the shape of the lower part.

According to an embodiment, while the panel slider has been assembled to the bracket and the articulated appendix has been pivoted in the vertical gap between the slider bracket and the door sill, the panel slider is configured to reduce the vertical gap.

According to an embodiment, the slider bracket comprises an aperture configured to receive the panel slider.

According to an embodiment, the panel slider comprises a sliding part slidable in the groove of the sill.

According to an embodiment, the panel slider comprises a fixing part cooperating with the aperture.

According to an embodiment, the fixing part comprises securing means providing secure fixing of the panel slider to the slider bracket.

According to an embodiment, the securing means comprises a fixing means configured to lock the panel slider to the aperture. According to an embodiment, the fixing means comprises a flexible, tensionable or spring loaded claw or cantilever.

According to an embodiment, the securing means comprises a positioning means, such as a positioning protrusion, cooperating with the shape of the aperture and configured to prevent installing the panel slider in wrong position in the aperture.

It is also brought forward a new method for guiding an elevator door in an elevator door arrangement as described above and hereinafter, comprising:
assembling at least one panel slider bracket as described above and hereinafter to an elevator door panel, and
mounting at least one panel slider as described above and hereinafter to said at least one slider bracket.

The invention eliminates risks of non-compliancy with EN81-20 requirements caused by human mistakes happening during door installation or maintenance. Door safety is guaranteed independently by the presence of panel slider, a wearable component subject to replacement which is meant to be installed on site as last operation in door panel installation sequence and periodically removable for inspection.

Compliancy with EN81-71 requirements can be achieved thanks to a panel slider that once installed will further increase effectiveness of panel-sill hooking, limiting vertical clearance needed during installation. Such clearance if not limited will allow vertical lifting of door panel during impacts perpendicular to door opening direction which could lead to horizontal door panel labyrinth disengagement from door frame, compromising functioning of the door.

Special design of the preferably plastic slider allows compliancy to EN81-71 requirement, without hindering door installability.

### BRIEF DESCRIPTION OF THE DRAWINGS

The invention will in the following be described in greater detail by means of preferred embodiments with reference to the attached drawings, in which:

FIG. 1 shows a view of an elevator door panel with panel slider brackets,

FIG. 2 shows another view of the elevator door panel with a slider to be assembled to a slider bracket,

FIG. 3 shows a vertical gap between the slider bracket and a door sill while door panel top parts are engaged with a top lintel,

FIG. 4 shows the slider with an articulated appendix that bends following the shape of the slider bracket during installation,

FIG. 5 shows the articulated appendix acting as a shim between the slider bracket and a door sill,

FIG. 6 shows a door panel top part engaged with a top lintel,

FIGS. 7 and 8 show a securing means of the fixing part, in particular the positioning means, preventing the slider from becoming assembled wrongly in an aperture of the slider bracket, and

FIG. 9 shows different views of the slider.

### DETAILED DESCRIPTION

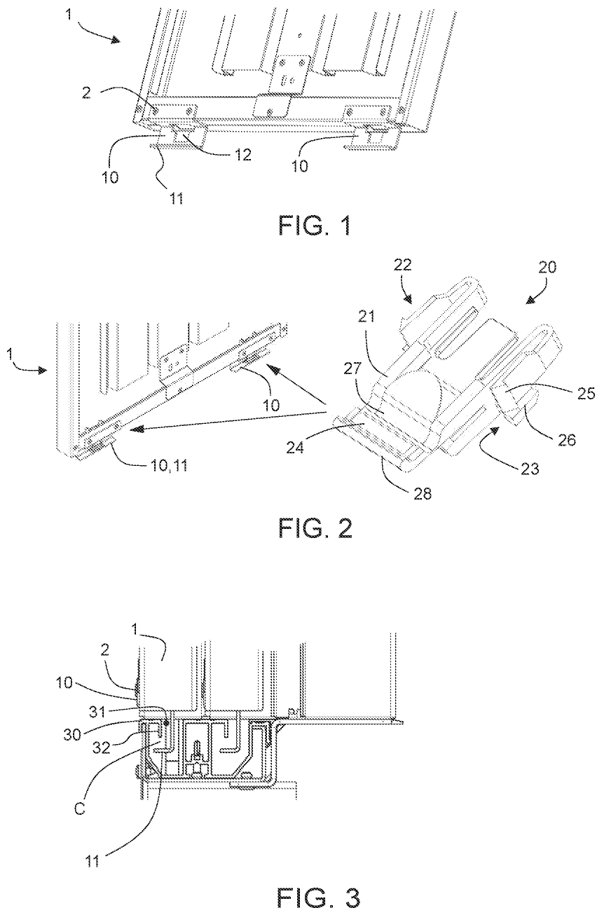

FIGS. 1-3 show embodiments of an elevator door arrangement. The arrangement comprises an elevator door panel 1 and a door sill 30. The door panel 1 is movable along the door sill 30. Further, the door panel 1 comprises at least one panel slider bracket 10. The at least one slider bracket 10 is movable in a groove 31 of the door sill 30. The arrangement comprises at least one panel slider 20 slidable in the groove 31 of the door sill 30 and mountable to said at least one slider bracket 10.

Features preventing door panel 1 derailment as required by EN81-20 are part of the panel slider bracket 10 attached in the Figures to the door panel 1 bottom.

According to an embodiment the slider bracket 10 is irremovable and assembled to the door panel 1 during panel manufacturing. This will remove risks of poor installation of the door or human mistakes.

According to an embodiment the slider bracket 10, installed in the groove 31 of the sill 30, is configured to generate a panel-sill hook.

According to an embodiment the slider bracket 10 has a lower part 11, which is configured in such a way that when it is installed inside the sill 30 though the groove 31, the lower part 11 is positioned below the sill structure 32, thus forming a vertical gap C between the lower part 11 and the sill structure 32.

The slider bracket 10 comprises a lateral protruding lower part 11 which in the assembled state of the elevator door arrangement extends below a sill structure 32 inside the sill 30.

According to an embodiment the slider bracket 10 has a lower part 11 comprising a lateral protruding extension to be assembled below a sill 30 structure 32 inside the sill 30.

According to an embodiment the slider bracket 10 comprises a hook formed lower part 11.

According to an embodiment the lower part 11 of the slider bracket 10 comprises a horizontal bend for retaining the door panel 1 against upward movement.

The lateral protruding lower part 11 such as the retaining bend is configured to catch on sill profile edges and hook the door when the door panel 1 lifts as effect of pendulum impacts.

According to an embodiment the slider bracket 10 is made of metal sheet.

According to an embodiment the panel slider bracket 10 is riveted with rivets 2 to the door panel 1.

When the at least one slider bracket 10 is riveted in the manufacturing line, the possibility of getting loose/ineffective thereof during the elevator life as could happen in case of screwed connection will be reduced. This will also prevent loss of EN81-20 compliancy in case fitter or maintenance mechanics won't correctly install this component. Installation and inspection of wearable parts e.g. panel sliders 20 doesn't require slider bracket 10 disassembling.

Compliancy with EN81-71 requirements is achieved with the panel slider 20 slidable in the door sill 30 groove 31.

According to an embodiment the slider bracket 10 comprises an aperture 12 configured to receive the panel slider 20.

FIG. 2 shows a view of the door panel 1 with the slider 20 to be assembled to the slider bracket 10. The slider 20 comprises a sliding part 21 slidable in the groove 31 of the sill 30. The sliding part 21 slides in the groove 31 when the door panel 1 is moved in the door opening and closing directions.

According to an embodiment the slider 20 comprises a fixing part 22 cooperating with the aperture 12 in the slider bracket 10 so that the slider 20 is kept in place in the aperture 12, in particular during operation of the arrangement, and the fixing part 22 prevents the slider 20 from becoming detached from its place.

According to an embodiment the fixing part 22 comprises securing means 23 providing secure fixing of the slider 20 in the slider bracket 10.

According to an embodiment the securing means 23 comprises a fixing means 25 such as a flexible, tensionable or spring loaded claw 25 or cantilever configured to lock the slider 20 in the aperture 12 of the slider bracket 10.

According to an embodiment the securing means 23 comprises a positioning means 26 such as a positioning protrusion 26 cooperating with the shape of the aperture 12 and configured to prevent installing the slider 20 in wrong position in the aperture 12 of the slider bracket 10. To prevent mistakes in panel slider 20 installation orientation, a poka-yoke or “mistake-proofing” feature has been added on flexible retaining cantilevers or claws 25, thick areas 26 which will get in interference with the slider bracket 10 aperture 12 when the slider 20 will be inserted with opposite orientation. Thus, by the shape of the slider the possibility of inserting the slider in the wrong direction is avoided.

A certain gap is needed between the lateral protruding lower part 11 such as the retaining bend 11 in slider brackets 10 and matching edges 32 in sill 30 profile, allowing fitters to lift the door panel 1 above bends in a top lintel 4 and engage horizontal fire labyrinths 3 present at the top of the panel 1 to them.

FIG. 3 shows a vertical clearance C between the slider bracket 10 and the door sill 30 while a door panel top 3 is engaged with a top lintel 4, see also FIG. 6.

The panel slider 20 once installed in the aperture 12 of the bracket 10 which is installed in the groove 31 will further increase the effectiveness of the panel-sill hook by limiting the vertical clearance C that is needed during installation. Such vertical clearance C or vertical gap C, if not limited, will allow vertical lifting of the door panel 1 during impacts (e.g. perpendicular to door opening direction) which could lead to door panel labyrinth 3 horizontal disengagement from door frame upper part 4 or lintel upper part 4, thus compromising functioning of the door.

The slider 20 is configured to limit the vertical clearance C between the lower part 11 of the slider bracket 10 and the sill 30.

According to an embodiment the slider 20 comprises an articulated appendix 24 such as a flange 24 configured to limit the vertical clearance C between the lower part 11 of the slider bracket 10 and the sill 30.

According to an embodiment the articulated appendix 24 is pivoted at an area or point 27 below the sliding part 21. According to an embodiment the area or point 27 comprises a joint or pivot. According to an embodiment the area or point 27 comprises material with reduced material thickness and/or flexible material.

According to an embodiment the slider 20 comprises an articulated appendix 24 acting as an integrated deformable shim 24.

According to an embodiment the articulated appendix 24 comprises a nose part 28 configured to follow the shape of the lower part 11. According to an embodiment the nose part 28 comprises a rounded or chamfered shape to facilitate following the shape of the lower part 11.

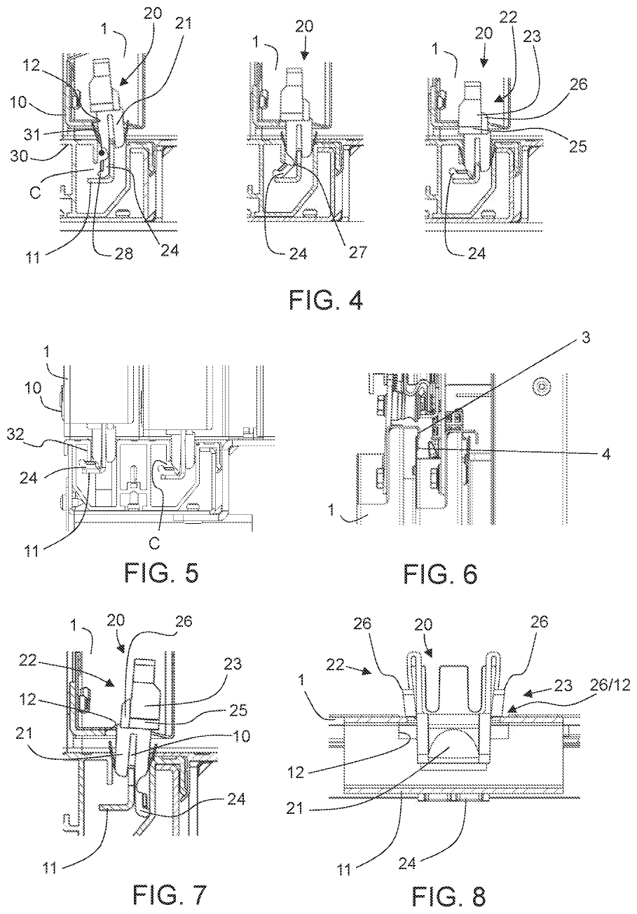

FIG. 4 shows the slider 20 with the articulated appendix 24 that bends following to the shape of the slider bracket 10 during installation when the door panel 1 is guided in the elevator door arrangement.

According to a first example step the slider 20 is inserted vertically through the aperture 12, the sliding part 21 moving into the groove 31.

According to a second example step the slider 20 is further moved downwards so that the articulated appendix 24 is pivoted, preferably at area 27, in the vertical gap C following the shape of the lower part 11 of the slider bracket 10. The securing means 23 of the fixing part 22, in particular the positioning means 26, prevent the slider 20 from becoming assembled wrongly in the aperture 12. A location of preventing is denoted with arrow 26/12.

According to a third example step the slider 20 with the articulated appendix 24 located in the vertical gap C provides for reduced vertical movement of the door panel 1. The securing means 23 of the fixing part 22, in particular the fixing means 25 prevent the slider 20 from becoming detached from its place in the aperture 12.

FIGS. 7 and 8 show a securing means 23 of the fixing part, in particular the positioning means 26, preventing the slider 20 from becoming assembled wrongly in an aperture 12 of the slider bracket 10.

According to an embodiment the articulated appendix 24 is configured to bend according to the shape of the slider bracket 10 lower end during installation.

According to an embodiment the articulated appendix 24 is provided at a lower end of the sliding part 21.

According to an embodiment the articulated appendix 24 will act as a shim while being positioned in the vertical gap C between the lower part 11 of the bracket 10 and the sill 30.

According to an embodiment the articulated appendix 24 is pivotable according to the shape of the lower part 11 of the slider bracket 10.

According to an embodiment the articulated appendix 24 is pivotable to a position perpendicular to a vertical assembly and disassembly movement direction of the slider 20.

According to an embodiment the slider 20 while assembled to the bracket 10 and the articulated appendix 24 being pivoted in the vertical gap C is configured to reduce the vertical gap C between the slider bracket 10 and the door sill 30.

The articulated appendix 24 in the vertical gap will reduce the allowed vertical movement of the door panel 1 shown FIG. 5 and prevent the door panel 1 top labyrinth 3 shown in FIG. 6 from disengaging from the lintel 4 during impact test and use of the elevator door arrangement.

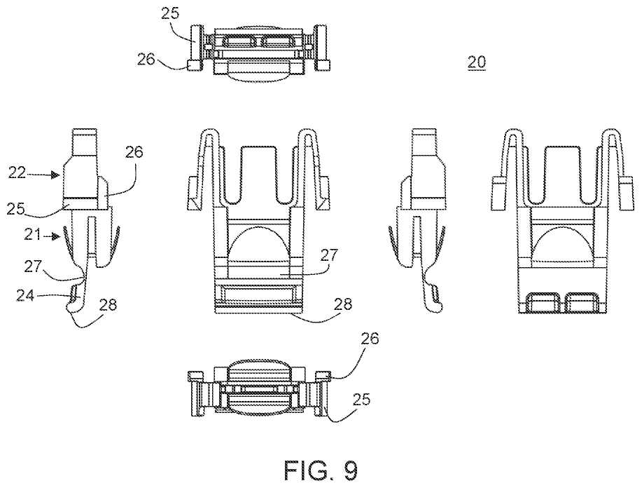

FIG. 9 shows different views of the slider 20.

It will be obvious to a person skilled in the art that, as the technology advances, the inventive concept can be implemented in various ways. The invention and its embodiments are not limited to the examples described above but may vary within the scope of the claims.

1. An elevator door arrangement, comprising:
an elevator door panel;
a door sill, wherein the door panel is movable along the door sill and comprises at a bottom thereof at least one panel slider bracket being movable in a groove of the door sill; and
at least one panel slider mountable to said at least one panel slider bracket and slidable in the groove,
wherein the at least one panel slider bracket comprises a lateral protruding lower part configured inside the door sill to extend below a sill structure.

2. The arrangement according to claim 1, wherein the slider bracket is assembled to the door panel during panel manufacturing.

3. The arrangement according to claim 1, wherein the slider bracket, when installed in the groove of the door sill, is configured to generate a panel-sill hook.

4. The arrangement according to claim 1, wherein the slider bracket has the lower part configured in such a way that when the slider bracket is installed inside the door sill through the groove, the lower part is positioned below the sill structure, thus forming a vertical gap between the lower part and the sill structure.

5. The arrangement according to claim 1, wherein the slider bracket has the lower part comprising a lateral protruding extension to be assembled below the sill structure inside the door sill.

6. The arrangement according to claim 1, wherein the lower part of the slider bracket comprises a horizontal bend for retaining the door panel against upward movement.

7. The arrangement according to claim 6, wherein the lateral protruding lower part is configured to catch on a sill profile edge and hook the door when the door panel lifts as effect of pendulum impacts.

8. The arrangement according to claim 1, wherein the panel slider is configured to limit the vertical gap between the lower part and the sill structure.

9. The arrangement according to claim 1, wherein the panel slider comprises an articulated appendix configured to limit the vertical gap between the lower part and the sill structure.

10. The arrangement according to claim 9, wherein the articulated appendix is configured to bend following a shape of the slider bracket lower end during installation, or the articulated appendix is pivotable according to a shape of the lower part of the slider bracket.

11. The arrangement according to claim 9, wherein while the panel slider has been assembled to the bracket and the articulated appendix has been pivoted in the vertical gap between the lower part and the sill structure, the panel slider is configured to reduce the vertical gap.

12. The arrangement according to claim 1, wherein the slider bracket comprises an aperture configured to receive the panel slider and the panel slider comprises a sliding part slidable in the groove of the door sill.

13. The arrangement according to claim 12, wherein the panel slider comprises a fixing part cooperating with the aperture.

14. The arrangement according to claim 13, wherein the fixing part comprises securing means providing secure fixing of the panel slider to the slider bracket.

15. A method for guiding an elevator door in the elevator door arrangement according to claim 1 comprising the steps of:
assembling said at least one panel slider bracket to said elevator door panel; and
mounting the at least one panel slider to said at least one slider bracket.

16. The arrangement according to claim 13, wherein the fixing part comprises securing means providing secure fixing of the panel slider to the slider bracket,
wherein the securing means comprises a fixing means configured to lock the panel slider to the aperture, and
wherein the securing means comprises a positioning means cooperating with the shape of the aperture and configured to prevent installing the panel slider in a wrong position in the aperture.

17. The arrangement according to claim 16, wherein the positioning means is a positioning protrusion.
